(19) United States
(12) Patent Application Publication
(10) Pub. No.: US 2025/0249798 A1
(43) Pub. Date: Aug. 7, 2025

(54) SEAT ASSEMBLY AND OFF-ROAD VEHICLE

(71) Applicant: KAWASAKI MOTORS, LTD., Hyogo (JP)

(72) Inventors: Takashi HISAMURA, Akashi-shi (JP); Akihiro FUKUMOTO, Akashi-shi (JP); Kazuki ISHIBASHI, Akashi-shi (JP)

(73) Assignee: KAWASAKI MOTORS, LTD., Hyogo (JP)

(21) Appl. No.: 18/434,975

(22) Filed: Feb. 7, 2024

(51) Int. Cl. B60N 2/06; B60N 2/16; B60N 2/20; B60R 22/02

(52) U.S. Cl. CPC B60N 2/06; B60N 2/16; B60N 2/20; B60R 2022/027

(57) ABSTRACT

A seat assembly 10 is attached to a vehicle body frame 1, and includes a slide frame 11 attached to the vehicle body frame 1 so as to move in a front-rear direction, a seat 13 attached to the slide frame 11, and a seatbelt 20 that secures an occupant in the seat 13. The seatbelt 20 includes a side belt 21 corresponding to a side portion of the abdomen of the occupant, and the side belt 21 is attached to the slide frame 11.

### FIELD

The technique disclosed here relates to a seat assembly and an off-road vehicle.

### BACKGROUND

FIG. 47 of U.S. Patent Application Publication No. 2021/0206438 shows a seat assembly. The seat assembly has a seat attached to a vehicle body frame so as to move in a front-rear direction and a seatbelt securing an occupant in the seat. The seatbelt is a six-point seatbelt, and includes a side belt corresponding to a side portion of the abdomen of the occupant. The side belt is fixed to the vehicle body frame in rear of the seat.

### SUMMARY

In the seat assembly as described above, the side belt is fixed to the vehicle body frame in rear of the seat, and therefore, does not follow movement of the seat when the occupant moves the seat forward. For this reason, there is a probability that the side portion of the abdomen of the occupant is excessively tightened with the side belt.

The technique disclosed here has been made in view of the above-described point, and an object thereof is to reduce excessive tightening of the side portion of the abdomen of the occupant.

The seat assembly disclosed here is a seat assembly attached to a vehicle body frame, which includes a slide frame attached to the vehicle body frame so as to move in a front-rear direction, a seat attached to the slide frame, and a seatbelt that secures an occupant in the seat. The seatbelt includes a side belt corresponding to a side portion of the abdomen of the occupant, and the side belt is attached to the slide frame.

The off-road vehicle disclosed here is an off-road vehicle including a vehicle body frame and a seat assembly attached to the vehicle body frame. The seat assembly includes a slide frame attached to the vehicle body frame so as to move in a front-rear direction, a seat attached to the slide frame, and a seatbelt that secures an occupant in the seat. The seatbelt includes a side belt corresponding to a side portion of the abdomen of the occupant, and the side belt is attached to the slide frame.

The above-described seat assembly can reduce excessive tightening of the side portion of the abdomen of the occupant.

The above-described off-road vehicle can reduce excessive tightening of the side portion of the abdomen of the occupant.

### BRIEF DESCRIPTION OF THE DRAWINGS

FIG. 1 is a left side view of a utility vehicle according to an embodiment.

FIG. 2 is a side view of a left front seat assembly from a vehicle-width outside.

FIG. 3 is a perspective view of the left front seat assembly from the front.

FIG. 4 is an enlarged side view of the left front seat assembly from the vehicle-width outside.

FIG. 5 is an enlarged plan view of the left front seat assembly from above.

FIG. 6 is a schematic front view of a slide adjuster from the front.

FIG. 7 is a schematic front view of a reclining adjuster from the front.

FIG. 8 is a schematic side view of a lift adjuster from the vehicle-width outside.

FIG. 9 is a schematic side view of the lift adjuster from a vehicle-width inside.

FIG. 10 is a schematic side view showing a state of a seat frame being moved upward by the lift adjuster.

FIG. 11 is a schematic plan view of a seat assembly according to a first modification.

FIG. 12 is a schematic plan view of a seat assembly according to a second modification.

### DESCRIPTION OF EMBODIMENTS

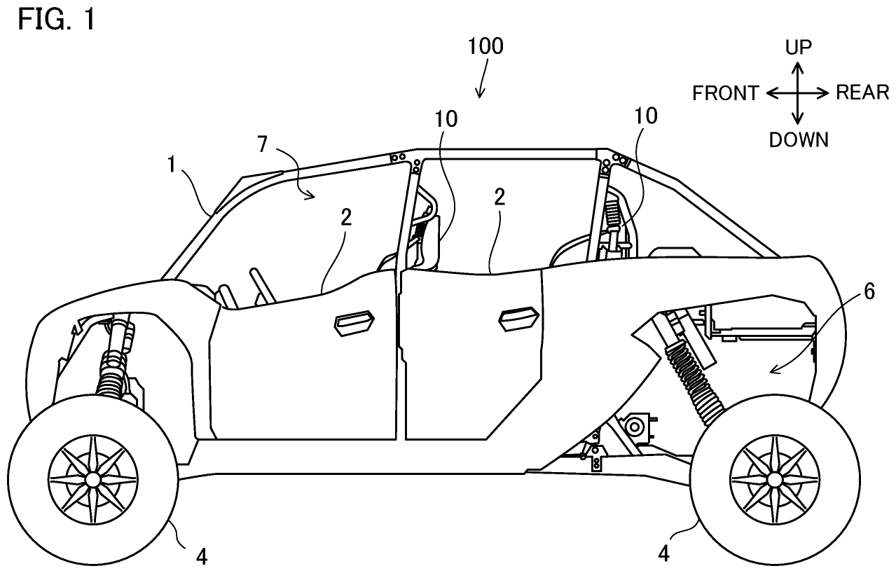

Hereinafter, an exemplary embodiment will be described in detail with reference to the drawings. FIG. 1 is a left side view of a utility vehicle 100. The utility vehicle 100 can travel off road. The utility vehicle 100 is one example of an off-road vehicle. Hereinafter, the utility vehicle 100 will also be merely referred to as a “vehicle 100.”

In the present disclosure, each component of the vehicle 100 will be described using a direction with respect to the vehicle 100. Specifically, a “front” means the front of the vehicle 100 in a vehicle front-rear direction, and a “rear” means the rear of the vehicle 100 in the vehicle front-rear direction. A “left” means the left when facing the front of the vehicle 100, and a “right” means the right when facing the front of the vehicle 100. A “width direction” means the vehicle width direction of the vehicle 100, and in other words, means the right-left direction of the vehicle 100 and will also be referred to as a “right-left direction.” A “vehicle-width inside” means a vehicle interior side in the width direction, and a “vehicle-width outside” means a vehicle outer side in the width direction. Each direction with respect to a seat assembly 10 is coincident with a corresponding direction with respect to the vehicle 100 when the seat assembly 10 is incorporated into the vehicle 100. For example, the front-rear direction of the seat assembly 10 is coincident with the front-rear direction of the vehicle 100 when the seat assembly 10 is incorporated into the vehicle 100.

The vehicle 100 includes a vehicle body frame 1 and the seat assembly 10. The vehicle 100 further includes a door 2 and a wheel 4. A vehicle interior 7 is defined in the vehicle body frame 1. The seat assembly 10 includes a front seat assembly (front seat) and a rear seat assembly (rear seat). The door 2 includes a front door and a rear door. The wheel 4 includes right and left front wheels and right and left rear wheels. That is, the vehicle 100 is a four-wheeled vehicle. An engine room 6 is located in rear of the vehicle body frame 1, specifically in rear of the rear seat. The engine room 6 houses a power unit. The power unit has, for example, an engine, a transmission that changes an output engine speed, a power generator that generates power with the power of the engine, and a battery that stores the power generated by the power generator.

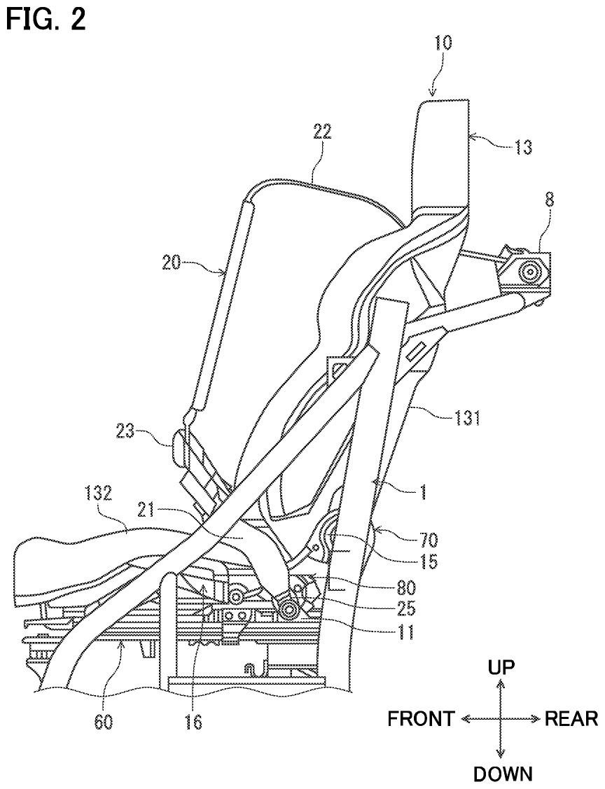

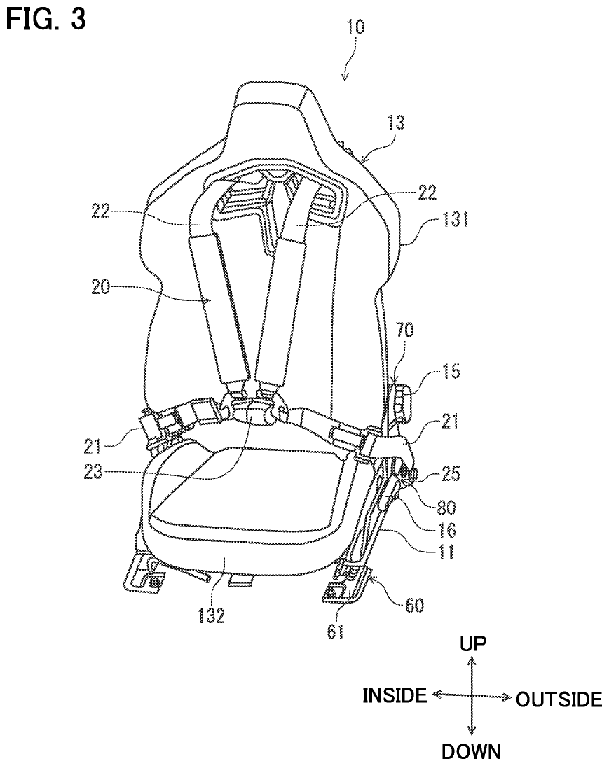

FIG. 2 is a side view of the left front seat assembly 10 from the vehicle-width outside. FIG. 3 is a perspective view of the left front seat assembly 10 from the front.

The seat assembly 10 is attached to the vehicle body frame 1. The seat assembly 10 includes a slide frame 11 attached to the vehicle body frame 1 so as to move in the front-rear direction, a seat 13 attached to the slide frame 11, and a seatbelt 20 securing an occupant in the seat 13.

The seat 13 has a back portion 131 supporting the back of the occupant and a seat portion 132 supporting the hip of the occupant. A hole penetrating the back portion 131 back and forth is located in an upper portion of the back portion 131.

In this embodiment, the seatbelt 20 is a four-point seatbelt. Specifically, the seatbelt 20 has two side belts 21 corresponding to the side portions of the abdomen of the occupant, two shoulder belts 22 corresponding to the shoulders of the occupant, and a buckle 23 coupling the side belts 21 and the shoulder belts 22 to each other. The buckle 23 has an internal portion to be connected to a first end portion of the left side belt 21 and a first end portion of the left shoulder belt 22 and an external portion to be connected to a first end portion of the right side belt 21 and a first end portion of the right shoulder belt 22. The external portion is inserted into and locked to the internal portion. A press button is disposed at the internal portion, and by pressing the press button, the external portion can be detached from the internal portion.

The side belt 21 is attached to the slide frame 11. Specifically, the seatbelt 20 includes an attachment portion 25 attaching the side belt 21 to the slide frame 11. The attachment portion 25 is, for example, a metal fitting. A second end portion of the side belt 21 is tied with the attachment portion 25. The attachment portion 25 is attached, with a screw, to a rear portion of the slide frame 11. FIGS. 2 and 3 show the attachment portion 25 connected to the left side belt 21. The same also applies to the attachment portion 25 connected to the right side belt 21, and such an attachment portion 25 is attached to the slide frame 11.

The shoulder belt 22 is inserted into the hole in the upper portion of the back portion 131, and a second end portion of the shoulder belt 22 is attached to the vehicle body frame 1. Specifically, the second end portion of the shoulder belt 22 is connected to a belt winder 8 attached to the vehicle body frame 1. The belt winder 8 winds and unwinds the shoulder belt 22. The belt winder 8 fixes the shoulder belt 22 such that the shoulder belt 22 is not unwound upon collision. FIG. 2 shows the belt winder 8 connected to the left shoulder belt 22, and the same also applies to a belt winder 8 connected to the right shoulder belt 22.

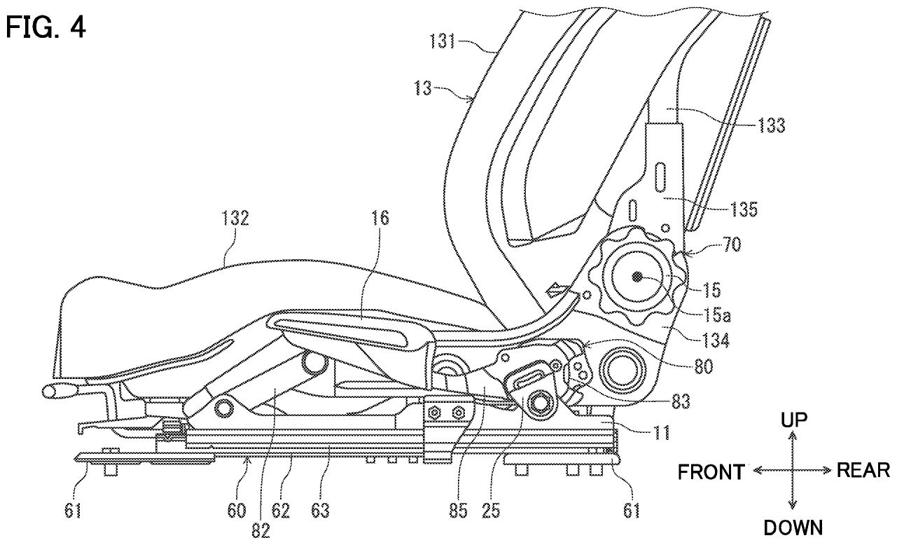

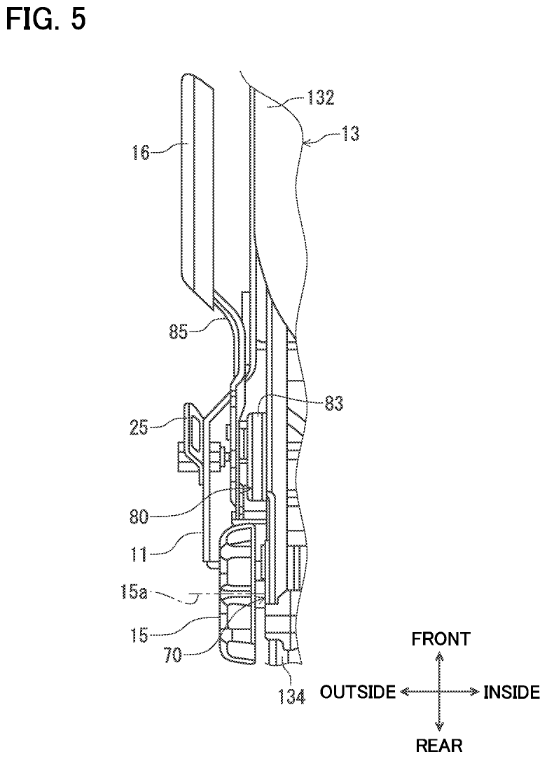

FIG. 4 is an enlarged side view of the left front seat assembly 10 from the vehicle-width outside. FIG. 5 is an enlarged plan view of the left front seat assembly 10 from above.

The seat 13 further has a back frame 133, a seat frame 134, and a coupling portion 135. The back frame 133 supports the back portion 131. The seat frame 134 supports the seat portion 132. The coupling portion 135 couples the back frame 133 and the seat frame 134 to each other. The coupling portion 135 is disposed on each side in the width direction. The seat frame 134 is attached to the slide frame 11.

The seat assembly 10 has a slide adjuster 60, a reclining adjuster 70, and a lift adjuster 80.

The slide adjuster 60 attaches the slide frame 11 to the vehicle body frame 1 such that the slide frame 11 is movable in the front-rear direction. That is, the slide frame 11 is attached to the vehicle body frame 1 through the slide adjuster 60.

The reclining adjuster 70 tilts the seat 13 back and forth. Specifically, the reclining adjuster 70 tilts the back portion 131 of the seat 13 back and forth. The reclining adjuster 70 is attached to the seat frame 134, and is movable relative to the vehicle body frame 1.

The lift adjuster 80 moves the seat 13 up and down. The lift adjuster 80 is attached to the seat frame 134, and is movable relative to the vehicle body frame 1. Note that the lift adjuster 80 may move only the seat portion 132 of the seat 13 up and down.

The seat assembly 10 has a reclining operator 15 and a lift operator 16. The reclining operator 15 operates the reclining adjuster 70, thereby performing an operation of tilting the back portion 131 of the seat 13 back and forth. The reclining operator 15 is a portion to be gripped by the occupant. The reclining operator 15 is a circular columnar dial operator. The reclining operator 15 includes a center 15a extending in the width direction.

The lift operator 16 operates the lift adjuster 80, thereby performing an operation of moving the seat 13 up and down. The lift operator 16 is a portion to be gripped by the occupant. The lift operator 16 is positioned in front with respect to the reclining operator 15. The lift operator 16 is a rod-shaped lever operator. The lift operator 16 extends in the front-rear direction.

The reclining operator 15 and the lift operator 16 are positioned on the vehicle-width outside of the seat assembly 10. Specifically, the reclining operator 15 and the lift operator 16 are positioned on the vehicle-width outside of the seat frame 134.

The attachment portion 25 is positioned in front with respect to the reclining operator 15. Specifically, the attachment portion 25 is positioned between the reclining operator 15 and the lift operator 16 in the front-rear direction. The attachment portion 25 is positioned on the vehicle-width outside of the seat frame 134. The lift operator 16 is positioned higher than the attachment portion 25. The reclining operator 15 is positioned higher than the lift operator 16.

The attachment portion 25 is positioned on the vehicle-width outside of the lift adjuster 80 as viewed from above. That is, the attachment portion 25 is positioned, as viewed from above, on the same line as that of the lift adjuster 80 in the width direction. Specifically, at the lowermost position of the seat 13 adjusted by the lift adjuster 80, the attachment portion 25 overlaps with the lift adjuster 80 as viewed in the width direction. Specifically, the attachment portion 25 overlaps with a torque transmitter 83 of the lift adjuster 80. FIGS. 3 and 4 show the lowermost position of the seat 13 (specifically, seat portion 132) adjusted by the lift adjuster 80.

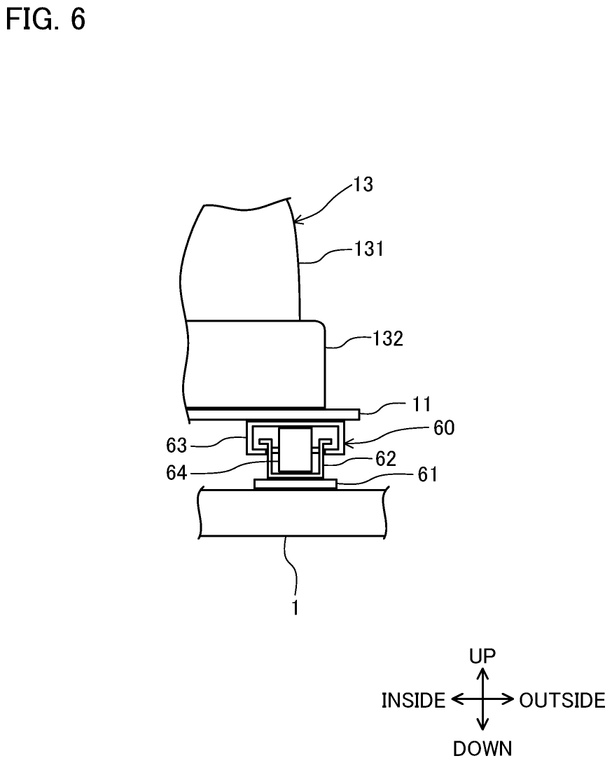

FIG. 6 is a schematic front view of the slide adjuster 60 from the front. FIG. 6 shows the slide adjuster 60 on the vehicle-width outside of the seat assembly 10. The slide adjuster 60 having a similar configuration is also disposed on the vehicle-width inside of the seat assembly 10. The slide adjuster 60 has a bracket 61, a rail 62, a guide 63, and a roller 64. Note that the slide adjuster 60 is not limited to this configuration and is only required to slide the slide frame 11 relative to the vehicle body frame 1.

The bracket 61 is fixed to the vehicle body frame 1. The rail 62 extends in the front-rear direction, and is fixed to the bracket 61. The guide 63 extends in the front-rear direction, and is fitted onto the rail 62. The roller 64 is located between the rail 62 and the guide 63, and is rotatably attached to the rail 62. The guide 63 is supported by the roller 64. With this configuration, the guide 63 is moved in the front-rear direction by the roller 64 while being guided by the rail 62.

The slide frame 11 is fixed onto the guide 63. With this configuration, the slide frame 11 is movable in the front-rear direction relative to the vehicle body frame 1. That is, the seat 13 (specifically, seat frame 134) attached to the slide frame 11 is movable in the front-rear direction relative to the vehicle body frame 1. Note that although not shown in the figure, the slide adjuster 60 has a seat lock fixing the position of the seat 13 in the front-rear direction.

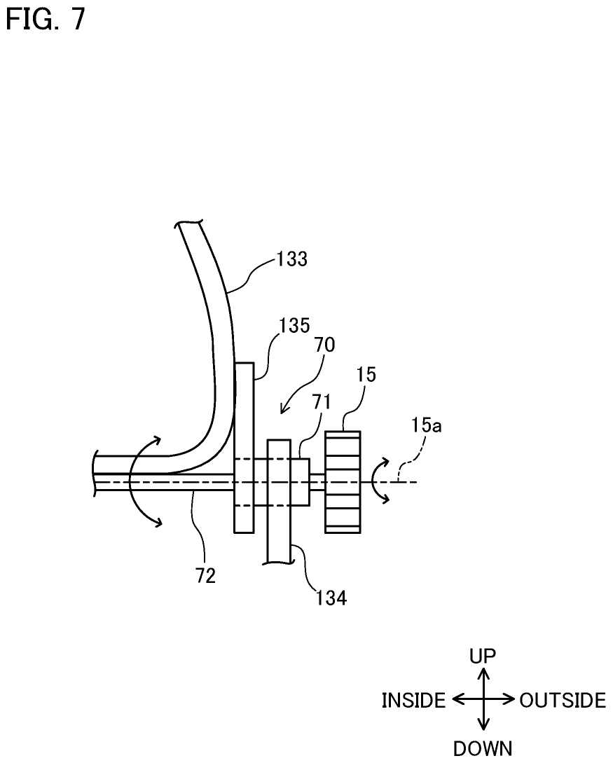

FIG. 7 is a schematic front view of the reclining adjuster 70 from the front. In FIG. 7, the back portion 131 is omitted. The reclining adjuster 70 has a gear transmitter 71 and a rod 72.

The gear transmitter 71 is attached to the seat frame 134. The gear transmitter 71 is connected to the coupling portion 135. The reclining operator 15 is attached to the gear transmitter 71. The rod 72 extends in the width direction, and is coupled to the coupling portions 135 on both sides in the width direction.

The gear transmitter 71 has an internal gear and an external gear engaging with each other, and transmits rotation of the reclining operator 15 to the coupling portions 135. Thus, when the reclining operator 15 rotates about the center 15a, the back frame 133 rotates about the center 15a through the coupling portions 135 on both sides in the width direction. That is, the back portion 131 is tiltable back and forth.

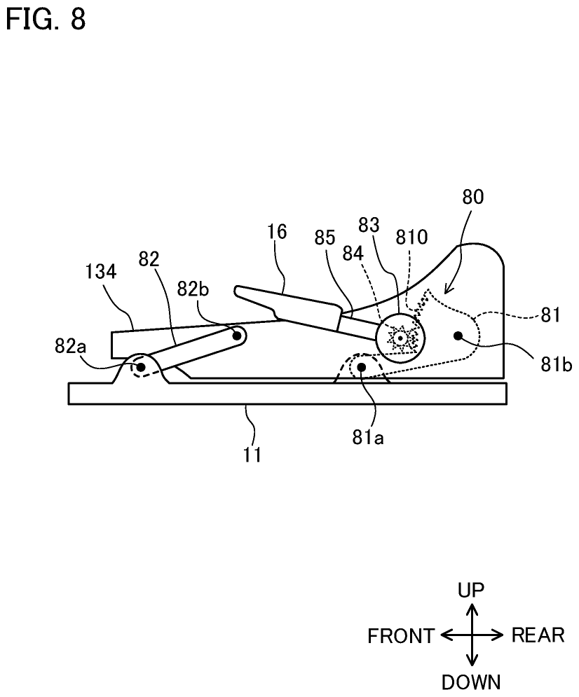

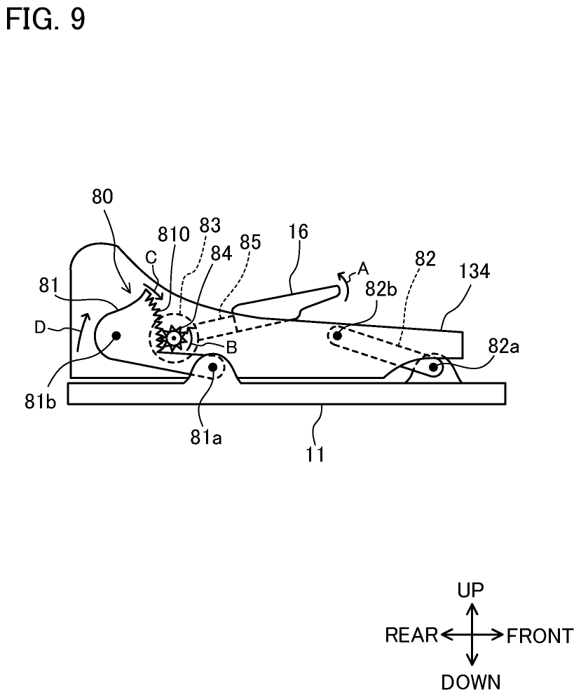

FIG. 8 is a schematic side view of the lift adjuster 80 from the vehicle-width outside. FIG. 9 is a schematic side view of the lift adjuster 80 from the vehicle-width inside. The lift adjuster 80 has a first link 81, a second link 82, the torque transmitter 83, and a pinion gear 84.

The first link 81 is positioned in rear with respect to the second link 82. The first link 81 is positioned on the vehicle-width inside of the seat frame 134. The first link 81 is coupled to the slide frame 11 at a first support point 81a, and is coupled to the seat frame 134 at a second support point 81b. The first link 81 has a lifter gear 810 at an end portion on the second support point 81b side.

The second link 82 is positioned on the vehicle-width outside of the seat frame 134. The second link 82 is coupled to the slide frame 11 at a first support point 82a, and is coupled to the seat frame 134 at a second support point 82b. With this configuration, the seat frame 134 is movable up and down relative to the slide frame 11 through the first link 81 and the second link 82.

The torque transmitter 83 is attached to the seat frame 134. The lift operator 16 is connected to an input shaft of the torque transmitter 83 through a coupling bar 85. The pinion gear 84 is connected to an output shaft of the torque transmitter 83. The pinion gear 84 is positioned on the vehicle-width inside of the seat frame 134, and engages with the lifter gear 810 of the first link 81. The torque transmitter 83 has a clutch structure, and transmits torque from the input shaft side to the output shaft side and does not transmit torque from the output shaft side to the input shaft side. The torque transmitter 83 has such a ratchet structure that only rotative force obtained by turn of the lift operator 16 in one arbitrarily-selected direction can be output. That is, the torque transmitter 83 can output rotative force in one arbitrary direction by repeated reciprocating rotation of the lift operator 16.

Subsequently, the features of the lift adjuster 80 will be described.

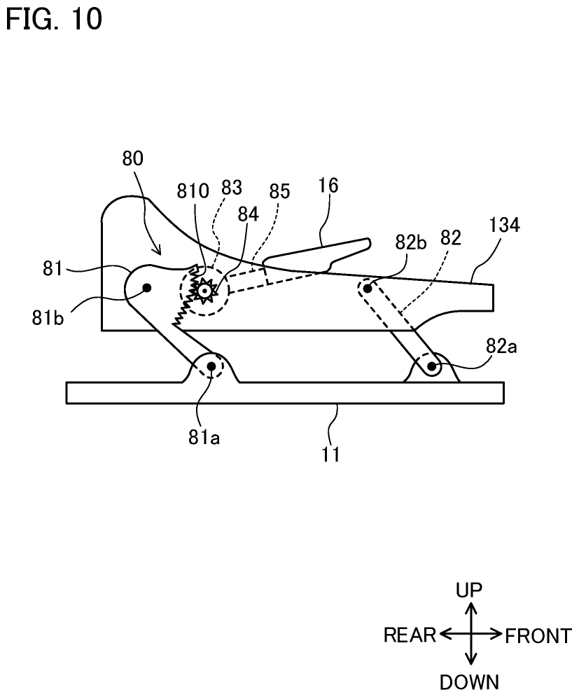

In a case of lifting the seat frame 134 (i.e., seat 13), the lift operator 16 is operated in the upward direction indicated by an arrow A. The pinion gear 84 moves in conjunction with operation of the lift operator 16 through the torque transmitter 83, and rotates in the direction of an arrow B which is the same direction as the direction of the arrow A. The lifter gear 810 rotates in conjunction with movement of the pinion gear 84 in the direction of an arrow C which is the opposite direction of the direction of the arrow B. That is, the first link 81 rotates about the first support point 81a in the direction of an arrow D. Accordingly, as shown in FIG. 10, the seat frame 134 moves upward about the first support point 81a of the first link 81 and the first support point 82a of the second link 82.

In a case of lowering the seat frame 134 (i.e., seat 13), the lift operator 16 is operated in the downward direction opposite to the direction of the arrow A. The pinion gear 84 rotates in the opposite direction of the direction of the arrow B. The lifter gear 810 rotates in the opposite direction of the direction of the arrow C. That is, the first link 81 rotates about the first support point 81a in the opposite direction of the direction of the arrow D. Accordingly, as shown in FIG. 9, the seat frame 134 moves downward about the first support point 81a of the first link 81 and the first support point 82a of the second link 82.

According to the above-described seat assembly 10, the side belt 21 of the seatbelt 20 is attached to the slide frame 11, and therefore, the side belt 21 moves so as to follow movement of the seat 13 when the occupant moves the seat 13 forward through the slide adjuster 60. Thus, upon forward movement of the seat 13, the side portion of the abdomen of the occupant is less likely to be excessively tightened with the side belt 21, and excessive tightening of the side portion of the abdomen of the occupant can be reduced.

The attachment portion 25 is positioned in front with respect to the reclining operator 15, and therefore, contact between the side belt 21 and the reclining operator 15 can be prevented and the reclining operator 15 can be favorably operated.

The attachment portion 25 is positioned between the lift operator 16 and the reclining operator 15 in the front-rear direction, and therefore, contact of the side belt 21 with the lift operator 16 and the reclining operator 15 can be prevented and the lift operator 16 and the reclining operator 15 can be favorably operated.

The reclining operator 15 is the dial operator, and therefore, can be reduced in size.

The attachment portion 25 is positioned on the vehicle-width outside of the lift adjuster 80 as viewed from above, and therefore, the dimension of the seat assembly 10 in the front-rear direction can be reduced.

According to the above-described vehicle 100, the side belt 21 of the seatbelt 20 is attached to the slide frame 11, and therefore, follows movement of the seat 13 when the occupant moves the seat 13 forward. Thus, upon forward movement of the seat 13, the side portion of the abdomen of the occupant is less likely to be excessively tightened with the side belt 21, and excessive tightening of the side portion of the abdomen of the occupant can be reduced.

### First Modification

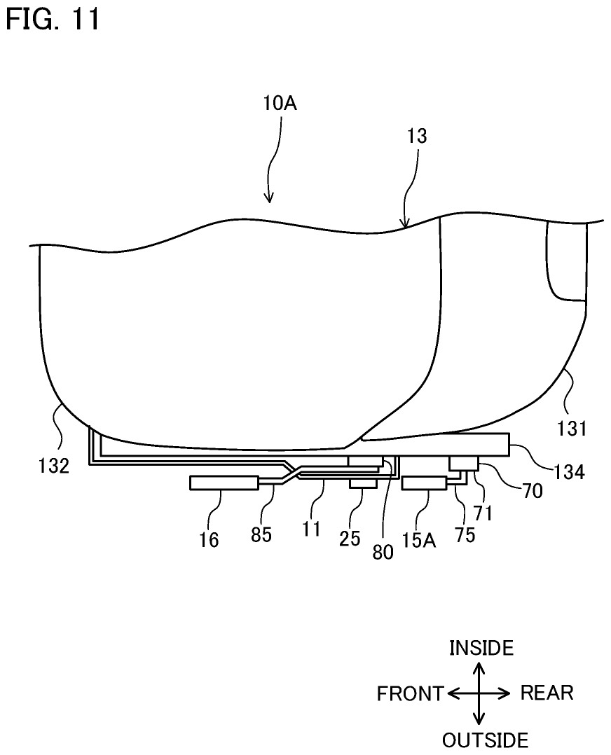

FIG. 11 is a schematic plan view of a seat assembly 10A according to a first modification. The seat assembly 10A according to the first modification is different from the seat assembly 10 according to the embodiment in the configuration of a reclining operator 15A. Hereinafter, a different configuration of the seat assembly 10A according to the first modification from that of the seat assembly 10 according to the embodiment will be mainly described. Note that in the seat assembly 10A according to the first modification, the same reference numerals as those of the seat assembly 10 according to the embodiment represent the same components as those of the seat assembly 10 according to the embodiment, and therefore, description thereof will be omitted.

In the seat assembly 10A according to the first modification, the reclining operator 15A is a rod-shaped lever operator. The reclining operator 15A extends in the front-rear direction. The reclining operator 15A is attached to the gear transmitter 71 through a coupling bar 75.

The reclining operator 15A, the lift operator 16, and the attachment portion 25 are linearly located in the front-rear direction as viewed from above. That is, the reclining operator 15A, the lift operator 16, and the attachment portion 25 are positioned on the same line in the front-rear direction as viewed from above.

The reclining operator 15A, the lift operator 16, and the attachment portion 25 are located at different heights in an up-down direction. The reclining operator 15A, the lift operator 16, and the attachment portion 25 may be located at the same height in the up-down direction.

According to the seat assembly 10A of the first modification, the reclining operator 15A, the lift operator 16, and the attachment portion 25 are linearly located in the front-rear direction as viewed from above, and therefore, the dimension of the seat assembly 10A in the width direction can be reduced.

Note that although description of other configurations, features, and effects will be omitted, description of the seat assembly 10 according to the embodiment can be used in description of the seat assembly 10A according to the first modification.

### Second Modification

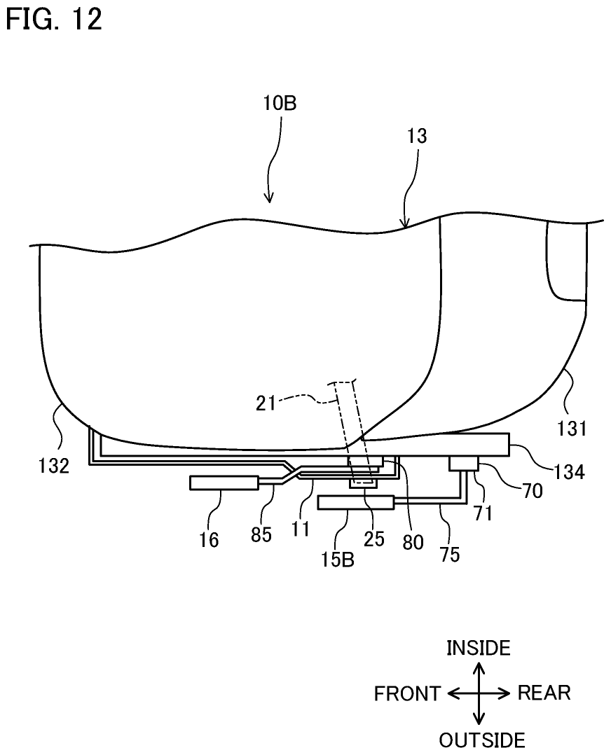

FIG. 12 is a schematic plan view of a seat assembly 10B according to a second modification. The seat assembly 10B according to the second modification is different from the seat assembly 10 according to the embodiment in the configuration of a reclining operator 15B. Hereinafter, a different configuration of the seat assembly 10B according to the second modification from that of the seat assembly 10 according to the embodiment will be mainly described. Note that in the seat assembly 10B according to the second modification, the same reference numerals as those of the seat assembly 10 according to the embodiment represent the same components as those of the seat assembly 10 according to the embodiment, and therefore, description thereof will be omitted.

In the seat assembly 10B according to the second modification, the reclining operator 15B is a rod-shaped lever operator. The reclining operator 15B extends in the front-rear direction. The reclining operator 15B is attached to the gear transmitter 71 through a coupling bar 75.

The attachment portion 25 is positioned on the vehicle-width inside with respect to the reclining operator 15B. Specifically, the attachment portion 25 is positioned on the vehicle-width inside of the reclining operator 15B as viewed from above. That is, the attachment portion 25 and the reclining operator 15B are positioned on the same line in the width direction as viewed from above.

The attachment portion 25 and the reclining operator 15B are located at different heights in the up-down direction. The attachment portion 25 and the reclining operator 15B may be located at the same height in the up-down direction.

According to the seat assembly 10B of the second modification, the attachment portion 25 is positioned on the vehicle-width inside with respect to the reclining operator 15B, and therefore, contact between the side belt 21 and the reclining operator 15B can be prevented and the reclining operator 15B can be favorably operated. Moreover, while contact between the side belt 21 and the reclining operator 15B is avoided, the reclining operator 15B can be extended to the vicinity of a hand of the occupant and the operability of the reclining operator 15B can be improved.

Note that although description of other configurations, features, and effects will be omitted, description of the seat assembly 10 according to the embodiment can be used in description of the seat assembly 10B according to the second modification.

### OTHER EMBODIMENTS

The embodiment has been described above as an example of the technique disclosed in the present application. However, the technique in the present disclosure is not limited to above, and is also applicable to embodiments to which changes, replacements, additions, omissions, etc. are made as necessary. The components described above in the embodiment may be combined to form a new embodiment. The components shown in the attached drawings and described in detail may include not only components essential for solving the problems, but also components that are provided for describing an example of the above-described technique and are not essential for solving the problems. Thus, description of these non-essential components in detail and illustration of these components in the attached drawings shall not be interpreted that these non-essential components are essential.

For example, the seat assembly 10 includes the front seat assembly (front seat) and the rear seat assembly (rear seat), but may include only the front seat or include three or more rows of seats.

In the above-described embodiment, the seatbelt 20 is the four-point seatbelt, but may be a six-point seatbelt. Specifically, the six-point seatbelt has foot belts corresponding to the thighs in addition to the side belts 21 and the shoulder belts 22.

In the above-described embodiment, the side belt 21 is attached to the slide frame 11 through the attachment portion 25, but an end portion of the side belt 21 may be directly attached to the slide frame 11.

In the above-described embodiment, the lift operator 16 is the rod-shaped lever operator, but may be a circular columnar dial operator.

In the above-described embodiment, the seat assembly 10 has the reclining operator 15 and the lift operator 16, but may have only the reclining operator 15 out of the reclining operator 15 and the lift operator 16.

In the above-described embodiment, the seat assembly 10 has the reclining adjuster 70 and the lift adjuster 80, but may have only the reclining adjuster 70 out of the reclining adjuster 70 and the lift adjuster 80.

In the above-described embodiment, the attachment portion 25 is positioned on the vehicle-width outside of the lift adjuster 80 as viewed from above, but is not necessarily positioned on the same line as that of the lift adjuster 80 in the width direction as viewed from above.

In the above-described embodiment, the left front seat assembly 10 has been described, but needless to say, the technique disclosed here is also applicable to the right front seat assembly 10, the left rear seat assembly 10, and the right rear seat assembly 10.

The technique disclosed here may be applied to an off-road vehicle other than the utility vehicle 100.

### Aspects

The above-described embodiment is a specific example of the following aspects.

### First Aspect

The seat assembly 10 is the seat assembly 10 attached to the vehicle body frame 1, which includes the slide frame 11 attached to the vehicle body 1 frame so as to move in the front-rear direction, the seat 13 attached to the slide frame 11, and the seatbelt 20 that secures the occupant in the seat 13. The seatbelt 20 includes the side belt 21 corresponding to the side portion of the abdomen of the occupant, and the side belt 21 is attached to the slide frame 11.

### Second Aspect

The seat assembly 10 of the first aspect further includes the reclining operator 15 that performs an operation of tilting the back portion 131 of the seat 13 back and forth (i.e., in the front-rear direction). The seatbelt 20 includes the attachment portion 25 attaching the side belt 21 to the slide frame 11, and the attachment portion 25 is positioned in front with respect to the reclining operator 15.

### Third Aspect

The seat assembly 10 of the first or second aspect further includes the lift operator 16 that performs an operation of moving the seat 13 up and down (i.e., in the up-down direction). The lift operator 16 is positioned in front with respect to the reclining operator 15, and the attachment portion 25 is positioned between the reclining operator 15 and the lift operator 16 in the front-rear direction.

### Fourth Aspect

In the seat assembly 10 of any one of the first to the third aspects, the reclining operator 15 is the circular columnar dial operator.

### Fifth Aspect

In the seat assembly 10A of any one of the first to fourth aspects, the reclining operator 15A is the rod-shaped lever operator, and the reclining operator 15A, the lift operator 16, and the attachment portion 25 are linearly located in the front-rear direction as viewed from above.

### Sixth Aspect

The seat assembly 10B of any one of the first to fifth aspects further includes the reclining operator 15B that performs an operation of tilting the back portion 131 of the seat 13 back and forth (i.e., in the front-rear direction). The seatbelt 20 includes the attachment portion 25 attaching the side belt 21 to the slide frame 11, and the attachment portion 25 is positioned on the vehicle-width inside with respect to the reclining operator 15B.

### Seventh Aspect

In the seat assembly 10 of any one of the first to sixth aspects, the reclining operator 15B is the rod-shaped lever operator.

### Eighth Aspect

The seat assembly 10 of any one of the first to seventh aspects further includes the lift adjuster 80 that moves the seat 13 up and down and is operated by the lift operator 16. The attachment portion 25 is positioned on the vehicle-width outside of the lift adjuster 80 as viewed from above.

### Ninth Aspect

The utility vehicle 100 (off-road vehicle) includes the vehicle body frame 1 and the seat assembly 10 attached to the vehicle body frame 1. The seat assembly 10 includes the slide frame 11 attached to the vehicle body frame 1 so as to move in the front-rear direction, the seat 13 attached to the slide frame 11, and the seatbelt 20 that secures the occupant in the seat 13. The seatbelt 20 includes the side belt 21 corresponding to the side portion of the abdomen of the occupant, and the side belt 21 is attached to the slide frame 11.

What is claimed:

1. A seat assembly attached to a vehicle body frame, comprising:
a slide frame attached to the vehicle body frame so as to move in a front-rear direction;
a seat attached to the slide frame; and
a seatbelt that secures an occupant in the seat,
wherein the seatbelt includes a side belt corresponding to a side portion of an abdomen of the occupant, and the side belt is attached to the slide frame.

2. The seat assembly of claim 1, further comprising:
a reclining operator that performs an operation of tilting a back portion of the seat back and forth,
wherein the seatbelt includes an attachment portion attaching the side belt to the slide frame, and the attachment portion is positioned in front with respect to the reclining operator.

3. The seat assembly of claim 2, further comprising:
a lift operator that performs an operation of moving the seat up and down,
wherein the lift operator is positioned in front with respect to the reclining operator, and the attachment portion is positioned between the reclining operator and the lift operator in the front-rear direction.

4. The seat assembly of claim 2, wherein
the reclining operator is a circular columnar dial operator.

5. The seat assembly of claim 3, wherein
the reclining operator is a rod-shaped lever operator, and
the reclining operator, the lift operator, and the attachment portion are linearly located in the front-rear direction as viewed from above.

6. The seat assembly of claim 1, further comprising:
a reclining operator that performs an operation of tilting a back portion of the seat back and forth,
wherein the seatbelt includes an attachment portion attaching the side belt to the slide frame, and the attachment portion is positioned on a vehicle-width inside with respect to the reclining operator.

7. The seat assembly of claim 6, wherein
the reclining operator is a rod-shaped lever operator.

8. The seat assembly of claim 3, further comprising:
a lift adjuster that moves the seat up and down and is operated by the lift operator,
wherein the attachment portion is positioned on a vehicle-width outside of the lift adjuster as viewed from above.

9. An off-road vehicle comprising:
a vehicle body frame; and
a seat assembly attached to the vehicle body frame,
wherein the seat assembly includes
a slide frame attached to the vehicle body frame so as to move in a front-rear direction,
a seat attached to the slide frame, and
a seatbelt that secures an occupant in the seat, and
the seatbelt includes a side belt corresponding to a side portion of an abdomen of the occupant, and the side belt is attached to the slide frame.
